(19) United States
(12) Patent Application Publication
(10) Pub. No.: US 2026/0291111 A1
(43) Pub. Date: Sep. 24, 2026

(54) BASE CLIP WITH SNAP FIT FEATURES FOR ASSEMBLY OF SHUTTER ASSEMBLY FOR TAMPER RESISTANT ELECTRICAL RECEPTACLE

(71) Applicant: EATON INTELLIGENT POWER LIMITED, DUBLIN 4 (IE)

(72) Inventors: Manas Das, Pune (IN); Vinay Vikas Mane, Islampur (IN); Sushant Dilip Raut, Pune (IN); Girish Mruthunjaya, Marietta, GA (US)

(73) Assignee: EATON INTELLIGENT POWER LIMITED, DUBLIN 4 (IE)

(21) Appl. No.: 19/087,073

(22) Filed: Mar. 21, 2025

(51) Int. Cl. H01R 13/453; H01R 43/18

(52) U.S. Cl. CPC H01R 13/453; H01R 43/18

(57) ABSTRACT

Embodiments of a base clip for a tamper resistant shutter assembly are advantageously designed to facilitate an improved automated assembly process wherein the base clip can be snap fitted to an electrical receptacle cover. In one embodiment, the base clip is designed to be coupled to a spring and a shutter to form a shutter assembly, and the shutter assembly can subsequently be coupled to a receptacle over, by snap fitting the base clip to the receptacle cover. In another embodiment, the shutter and spring must be coupled to the receptacle cover prior to the base clip. Afterward, a lock protrusion of the base clip must be inserted into a lock insertion opening in the receptacle cover, and then a snap fit protrusion of the base clip can be snap fit to the receptacle cover to complete assembly of the shutter assembly.

### FIELD OF THE INVENTION

The disclosed concept relates generally to electrical receptacles and in particular, to shutter assemblies for tamper resistant electrical receptacles.

### BACKGROUND OF THE INVENTION

Electrical outlets enable devices and appliances with electrical plugs to receive electrical power (e.g. utility power or generator power) supplied to a building in residential, commercial, and industrial settings. An electrical outlet includes at least one receptacle structured to receive the prongs of electrical plugs. When an electrical plug is inserted into a receptacle in an electrical outlet, the plug prongs establish electrical contact with conductors conducting power provided to the building.

Electrical codes typically require that an outlet cover be used to cover the electrical components of electrical receptacles in a building. FIG. 1 shows a tamper-resistant outlet cover assembly 1 structured to provide access to an electrical outlet for up to two electrical plugs. The outlet cover assembly 1 includes a front cover 2 coupled to a rear cover 3, with the front cover 2 including two individual receptacle covers 4 (also referred to sometimes herein as “receptacles 4”), and each individual receptacle cover 4 being structured to provide access for a single plug to the building’s power supply. Each individual receptacle cover 4 includes a hot slot 5, a neutral slot 7, and a ground opening 8 structured to respectively receive the hot blade, neutral blade, and ground prong (if applicable) of a standard electrical plug. The outlet cover assembly 1 includes a hot terminal assembly 11 and a neutral terminal assembly 13 that can be electrically connected to the conductors that supply live power to the building (for example, from the utility electrical grid). Accordingly, when a standard electrical plug is inserted into one of the receptacles 4, the hot prong of the plug can electrically connect to the building’s hot conductor through the hot slot 5 and the neutral prong of the plug can electrically connect to the building’s neutral conductor through the neutral slot 7. The outlet cover assembly also includes a ground strap 15 that provides grounding for three-pronged electrical plugs.

The outlet cover assembly 1 is tamper-resistant, meaning that for each receptacle 4, a shutter assembly is installed between the receptacle cover 4 and the hot and neutral terminal assemblies 11, 13, in order to prevent objects other than standard plug prongs from accessing the live electrical terminal assemblies 11, 13. Electrical receptacles that include a shutter assembly are referred to as “tamper-resistant” and are desirable, for example, in areas likely to be accessible by children, in order to prevent a child who sticks a non-plug object into only the hot slot 5 or only the neutral slot 7 of a receptacle 3 from accessing the live electrical terminal assemblies 11, 13 and creating an electrocution hazard.

A shutter assembly ensures that, in the event an object is inserted into only one of the hot slot 5 or the neutral slot 7 (i.e. rather than being simultaneously inserted into both the hot slot 5 and the neutral slot 7, as a standard electrical plug is), the object will not be able to access and electrically connect to the live power supply. Without a shutter assembly, if an object were able to access and electrically connect to only the hot terminal assembly 11 (i.e. through the hot slot 5) or only the neutral terminal assembly 13 (i.e. through the neutral slot 7), the object could become a live conductor and present an electrocution hazard. Shutter assemblies are thus important for ensuring that electrical receptacles are as hazard-proof as possible. However, producing such shutter assemblies presents challenges, as shutter assemblies comprise several components, some of which are fairly minute in size, that require precise alignment for proper assembly. The quantity and relatively small size of the components required to produce a shutter assembly, as well as the alignment requirements, can complicate automation of the shutter manufacturing process, resulting in relatively high rejection rates during the automated production process and undesirable production inefficiencies.

There is thus room for improvement in shutter assemblies for tamper resistant electrical receptacles.

### SUMMARY OF THE INVENTION

These needs, and others, are met by embodiments of a base clip for a tamper resistant shutter assembly that are advantageously designed to facilitate an automated assembly process wherein the base clip can be snap fitted to an electrical receptacle cover, thus simplifying the assembly process and reducing error and rejection rates during assembly. The disclosed base clip embodiments are structured to be used with an existing shutter and spring. In a first embodiment, the base clip includes two snap lock protrusions. The first embodiment is designed to enable the shutter, spring, and base clip to all be coupled to one another to form a shutter assembly at a first stage of the assembly process. The entire shutter assembly can then be coupled to a receptacle cover by snap fitting the two snap lock protrusions into engagement with the receptacle cover. In a second embodiment, the base clip includes a lock protrusion and a snap fit protrusion. With the second embodiment, the shutter and spring must be coupled to the receptacle cover prior to the base clip being coupled to the receptacle cover. To couple the base clip to the receptacle cover after the shutter and the spring, the lock protrusion must first be inserted into a lock insertion opening formed in the receptacle cover, and afterward, the snap fit protrusion can be snap fit into a snap fit opening formed in the receptacle cover.

In one exemplary embodiment of the disclosed concept, a base clip for a tamper resistant shutter assembly for an electrical receptacle having a receptacle cover comprises: a main body that is planar in a width dimension and a height dimension, a coupling mechanism, a wedge arm, and a U-ended arm. The main body includes a hot opening and a neutral opening structured to respectively receive the hot prong and neutral prong of an electrical plug, with the hot opening and neutral opening being spaced apart from one another in the width dimension. The coupling mechanism includes a coupling base and two coupling legs. The wedge arm includes a wedge arm snap lock protrusion. The U-ended arm includes a U-ended arm snap lock protrusion. The base clip has a front side and a rear side, the front side being disposed in a frontward direction relative to the rear side and the rear side being disposed in a rearward direction (1002) relative to the front side. The frontward direction and the rearward direction are disposed in a depth dimension. The depth dimension, width dimension, and height dimension are all orthogonal to one other. The base clip is structured to be coupled to the receptacle cover with the front side facing the receptacle cover. The base clip is structured to be coupled to the receptacle cover by aligning the base clip with the receptacle cover and exerting a pushing force in the frontward direction on the receptacle cover. The wedge arm and U-ended arm are structured such that, when the pushing force is exerted on the receptacle cover, the wedge arm snap lock protrusion and the U-ended arm snap lock protrusion respectively snap fit into engagement with a first depression and a second depression formed in the receptacle cover. The base clip is structured such that the respective engagement between the wedge arm and the U-ended arm with the first depression and the second depression fixedly couples the base clip to the receptacle cover.

In another exemplary embodiment of the disclosed concept, a method for assembling a tamper resistant electrical receptacle arrangement comprises: coupling a base clip to a shutter and a spring to form a shutter assembly; and snap fitting the base clip to a receptacle cover after formation of the shutter assembly. Snap fitting the base clip to the receptacle cover completes assembly of the electrical receptacle arrangement. The base clip is structured such that snap fitting the base clip to the receptacle cover fixedly couples the shutter assembly to the receptacle cover.

In another exemplary embodiment of the disclosed concept, a base clip for a tamper resistant shutter assembly for an electrical receptacle having a receptacle cover comprises: a main body that is planar in a width dimension and a height dimension, a lock arm, and a snap fit arm. The main body includes a hot opening and a neutral opening structured to respectively receive the hot prong and neutral prong of an electrical plug, the hot opening and the neutral opening being spaced apart from one another in the width dimension. The lock arm includes a lock protrusion. The snap fit arm includes a snap fit protrusion. The lock arm and snap fit arm are disposed on opposite sides of the main body in the width dimension. The snap fit protrusion is structured to be snap fit into engagement with a snap fit depression of the receptacle cover. The lock arm and snap fit arm are structured such that, in order to couple the base clip to the receptacle cover, the lock protrusion must be inserted into a lock insertion opening of the receptacle cover prior to the snap fit protrusion being snap fit into engagement with the snap fit depression.

In a further exemplary embodiment of the disclosed concept, a method for assembling a tamper resistant electrical receptacle arrangement comprises: coupling a shutter and a spring to a receptacle cover; and coupling a base clip to the receptacle cover after the shutter and spring are coupled to the receptacle cover in order to form a complete shutter assembly. Coupling the base clip to the receptacle cover comprises: inserting a lock protrusion of the base clip into a lock insertion opening of the receptacle cover; and snap fitting a snap fit protrusion of the base clip into a snap fit depression after inserting the lock protrusion into the lock insertion opening.

### BRIEF DESCRIPTION OF THE DRAWINGS

A full understanding of the invention can be gained from the following description of the preferred embodiments when read in conjunction with the accompanying drawings in which:

FIG. 1 is a front view of a tamper-resistant outlet cover assembly used to provide access for an electrical plug to an electrical outlet in a building;

FIG. 2 is a partial isometric rear view of a tamper-resistant electrical receptacle arrangement that includes the front cover assembly shown in FIG. 1 and a shutter arrangement provided for each receptacle cover of the front cover assembly, with each shutter arrangement including a first base clip, in accordance with an example embodiment of the disclosed concept;

FIG. 3 is an exploded partial isometric rear view of the components of one of the tamper-resistant shutter arrangements shown in FIG. 2;

FIG. 4 is a partial isometric view of the rear side of the base clip shown in FIG. 3;

FIG. 5 is a partial isometric view of the front side of the base clip shown in FIG. 3;

FIG. 6A is an elevational sectional view of one of the outlet arrangements shown in the electrical receptacle arrangement of FIG. 2;

FIG. 6B is a rotated partial isometric sectional view of the outlet arrangement shown in FIG. 6A;

FIG. 7A is a partial isometric rear view of another electrical receptacle arrangement using a shutter assembly that includes a second base clip in accordance with another example embodiment of the disclosed concept, showing a first stage of installing the components of the shutter assembly in the front receptacle cover;

FIG. 7B is the partial isometric rear view of the electrical receptacle arrangement shown in FIG. 7A, showing a second stage of installing the components of the shutter assembly in the front receptacle cover;

FIG. 8 is a partial isometric view of the of the rear side of the base clip shown in FIGS. 7A-7B;

FIG. 9 is a partial isometric view of the of the front side of the base clip shown in FIGS. 7A-7B; and

FIG. 10 is an elevational sectional view of one of the outlet arrangements shown in the electrical receptacle arrangement of FIG. 7A-7B;

FIG. 11 is an enlarged view of one of the receptacle covers shown in FIGS. 7A-7B;

FIG. 12 is a flow chart of a method for assembling the tamper-resistant electrical receptacle arrangement shown in FIG. 2, in accordance with an example embodiment of the disclosed concept; and

FIG. 13 is a flow chart of a method for assembling the tamper-resistant electrical receptacle arrangement shown in FIGS. 7A-7B, in accordance with another example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

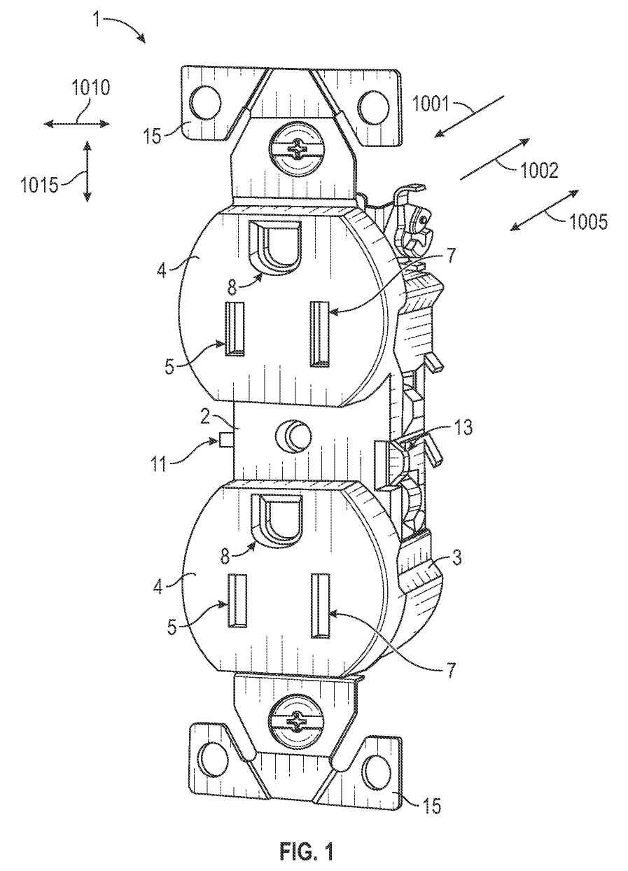

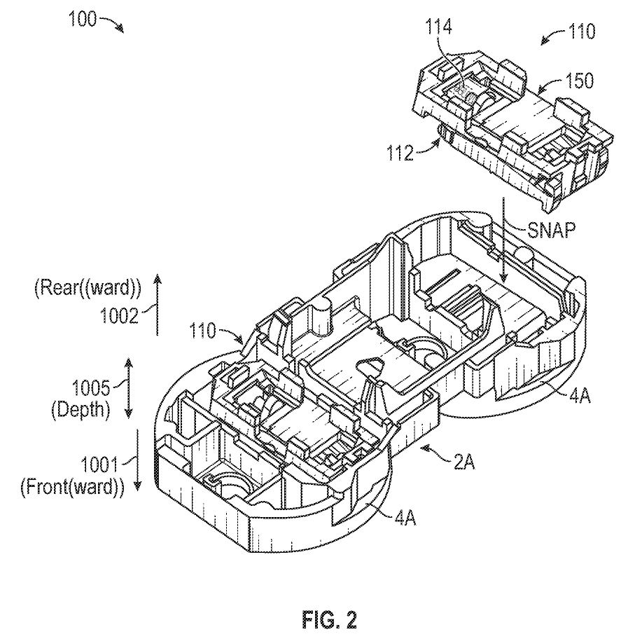

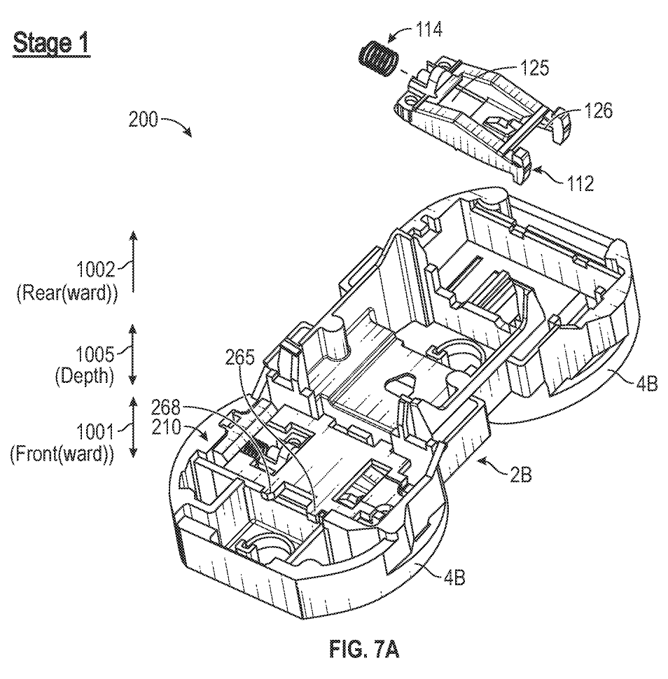

FIG. 2 shows a rear view of a tamper-resistant electrical receptacle arrangement 100 that includes an embodiment 2A of the front cover 2 shown in FIG. 1 and a shutter arrangement 110 for each individual receptacle cover 4A of the front cover 2A, with the shutter arrangement 110 including a base clip 150 in accordance with an exemplary embodiment of the disclosed concept. It is noted that the embodiment of the front cover 2 and the embodiment of the receptacle cover 4 structured for use with the shutter arrangement 110 are specifically numbered with the reference numbers 2A and 4A in FIGS. 2-6B (where applicable), because the receptacle cover 4A includes certain features that render it suitable for use with the shutter arrangement 110, while the reference number 4B is used where applicable in FIGS. 7A-10 to refer to a second embodiment of the receptacle cover 4 that is structured for use with another shutter arrangement 210 shown in FIGS. 7A-10. Accordingly, the front cover 2A is an embodiment of the front cover 2 that includes the receptacle covers 4A and the front cover 2B is an embodiment of the front cover 2 that includes the receptacle covers 4B. However, either front cover 2A, 2B may be referred to generally using the reference number 2 as applicable, and either receptacle cover 4A, 4B may be referred to generally using the reference number 4 as applicable.

It is further noted that the features of the outlet cover assembly 1 that are visible in FIG. 1 are known in the relevant technological field. However, the specific base clip 150 included in the shutter arrangement 110 of FIGS. 2-6B and detailed hereinafter in connection with those figures is not known in the relevant technological field. It should thus be noted that the shutter arrangement 110 and the electrical receptacle arrangement 100 formed by coupling the shutter arrangement 110 to the front cover 2 of FIG. 1 are unknown in the relevant technological field.

A second embodiment of a base clip not known in the relevant technological field, a base clip 250, is also disclosed herein in accordance with another exemplary embodiment of the disclosed concept, and is detailed later herein in conjunction with FIGS. 7A-10. It should thus also be noted that a shutter arrangement 210 and an electrical receptacle arrangement 200 formed by coupling the shutter arrangement 210 to the front cover 2 of FIG. 1 are also unknown in the relevant technological field.

In order to provide a common frame of reference between the figures, certain dimensions and directions are labeled in the figures. The labeled directions include a frontward direction 1001 and a rearward direction 1002. It will be appreciated that outlet cover assemblies such as the outlet cover assembly 1 are designed to be installed in a building so that the front cover 2 faces toward a user, and as such, the receptacle covers 4 are the front-most surfaces of the outlet cover assembly 1. Conversely, the side of the rear cover 3 disposed opposite the receptacle covers 4 faces away from the user and is the rear-most surface of the outlet cover assembly 1. As such, the frontward direction 1001 is depicted to denote orientation or movement toward the receptacle covers 4, and the rearward direction 1002 is depicted to denote orientation or movement opposite the frontward direction 1001. Components within the outlet cover assembly 1, within electrical receptacle arrangement 100 (FIGS. 2-6B), and within the electrical receptacle arrangement 200 (FIGS. 7A-10) are sometimes referred to hereinafter as being “front” or “rear”. It should be understood that referring to a component as a “front [component]” (e.g. a “front side”) herein signifies that said front component is disposed more frontward 1001 than other components in the structure. Similarly, it should be understood that referring to a component as a “rear [component]” (e.g. a “rear side”) herein signifies that said rear component is disposed more rearward 1002 than other components in the structure.

The frontward direction 1001 and rearward direction 1002 both lie in a depth dimension 1005. In addition to the depth dimension 1005, a width dimension 1010 and a height dimension 1015 are labeled in the figures. The depth dimension 1005, width dimension 1010, and height dimension 1015 are all orthogonal to one another. The use of the terms “front[ward]”, “rear[ward]”, “depth”, “width”, and “height” to refer to the directions and dimensions 1001, 1002, 1005, 1010, and 1015 is intended solely to describe the positions of various components in the electrical receptacle arrangement 100 relative to one another and should not be construed as limiting the orientation in which the electrical receptacle arrangement 100 can be used.

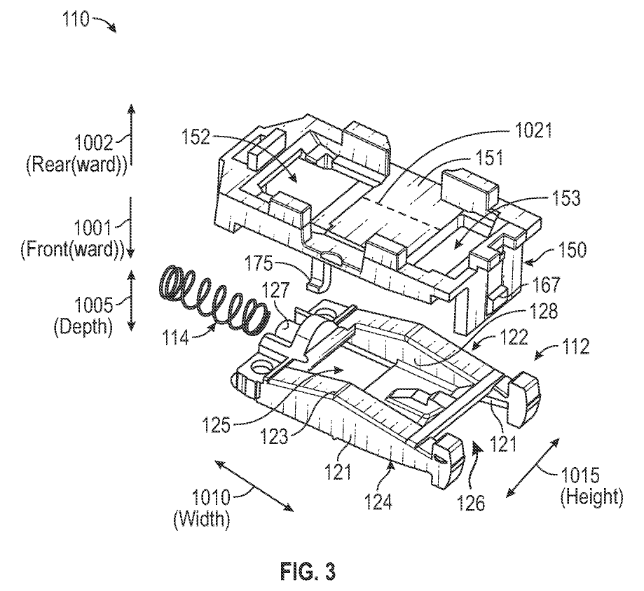

Reference is now made to FIG. 3 in conjunction with FIG. 2. As depicted in FIG. 2, each shutter arrangement 110 is structured to be coupled to the rear side of one of the individual receptacle covers 4. Each shutter arrangement 110 comprises a shutter 112, a spring 114, and a base clip 150 coupled to one another. As previously stated, the specific base clip 150 included in the shutter arrangement 110 is not known in the relevant technological field, but it is noted that the shutter 112 and spring 114 are existing designs. The shutter 112 and spring 114 have previously been used with an existing base clip to form a known shutter arrangement, but the design of the existing base clip results in moderate rates of rejection during the automated process for assembling the known shutter arrangement. The improved base clip 150 is advantageously structured compared to the existing base clip such that the automated process for assembling the shutter arrangement 110 and installing it in the front cover 2 to form the electrical receptacle arrangement 100 leads to lower rejection rates due to the inclusion of the improved base clip 150 instead of the existing base clip. Referring briefly again to the improved base clip 250 (which will be detailed later in conjunction with FIGS. 7A-10), the improved base clip 250 is also advantageously structured compared to the existing base clip such that the automated process for installing the shutter arrangement 210 in the front cover 2 to form the electrical receptacle arrangement 200 also leads to lower rejection rates due to the inclusion of the improved base clip 250 instead of the existing base clip. Because the shutter 112 and spring 114 are existing designs, their structural features are not discussed in extensive detail herein, although certain details of the shutter 112 and spring 114 are provided herein to the extent that they are relevant for understanding the advantageous features of the improved base clip 150 and the advantageous features of the improved base clip 250 described in the present disclosure.

The shutter arrangement 110 is structured to be fully assembled prior to being coupled to the receptacle cover 4A. The base clip 150 comprises snap fit features that enable it to be fixedly coupled to the receptacle cover 4A such that, when the shutter arrangement 110 is assembled, the shutter arrangement 110 can be snapped into engagement with the corresponding receptacle cover 4A via the snap fit features of the base clip 150. In FIG. 2, one shutter arrangement 110 is already coupled to one of the receptacle covers 4A, and the other shutter arrangement 110 is assembled and positioned to be snap fit to the other receptacle cover 4A, as indicated by the arrow labeled “SNAP”.

Referring briefly once more to FIG. 1, as previously noted, the outlet cover assembly 1 includes a hot terminal assembly 11 and a neutral terminal assembly 13. It is noted that most of the components of the terminal assemblies 11, 13 are contained within the outlet cover assembly 1, i.e. between the front cover 2 and the rear cover 3, and that only small portions of the terminal assemblies 11, 13 are visible in FIG. 1. A standard electrical plug is structured such that, when the plug is positioned for insertion into the receptacle cover 4A, the hot blade and the neutral blade of the plug are the same length (or very nearly the same length) as one another in the depth dimension 1005. Shutter arrangements such as the shutter arrangement 110 are designed to ensure that only a plug whose hot blade and neutral blade are the same length (with some tolerance for small variations) can make physical contact with the hot terminal assembly 11 and the neutral terminal assembly 13 when inserted into the hot slot 5 and neutral slot 7. Otherwise, if an object is inserted into the only the hot slot 5 or inserted into only the neutral slot 7, the shutter arrangement 110 prevents the object from physically contacting the live electrical terminal assemblies 11, 13. It is noted that if an electrical plug were to be damaged such that the hot blade is rendered significantly shorter than the neutral blade or vice versa, the shutter arrangement 110 would also prevent the hot blade and the neutral blade of the damaged electrical plug from physically contacting the live electrical terminal assemblies 11, 13. Hereinafter, any object that is not a standard electrical plug having a hot blade and a neutral blade of the same length in the depth dimension 1005 is referred to as a “non-plug object” for brevity. That is, even an object that was formerly a standard electrical plug but whose hot blade and neutral blade are now different lengths in the depth dimension 1005 is referred to hereinafter as a non-plug object.

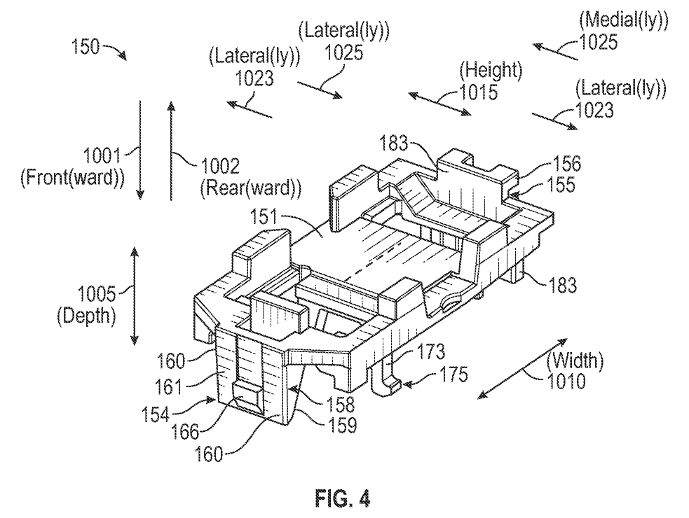

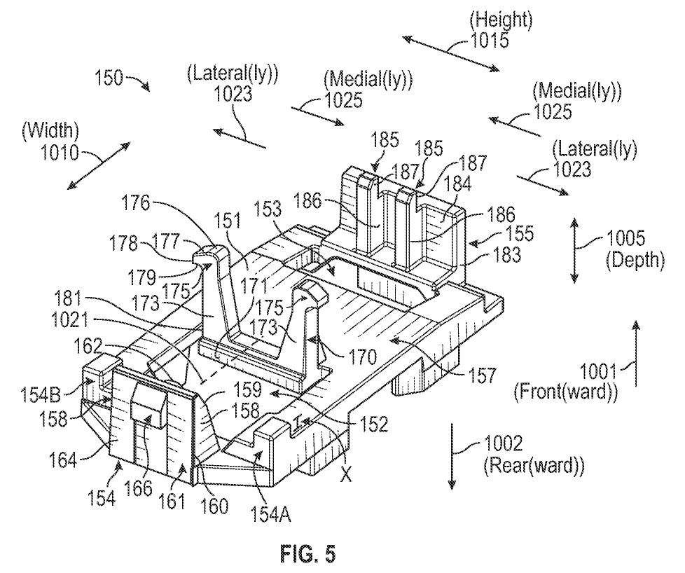

The general mechanics of how the shutter arrangement 110 prevents any non-plug object from accessing the live electrical terminal assemblies 11, 13 will now be explained. Referring to FIGS. 2-3 in conjunction with FIG. 4 (which shows the rear side of the base clip 150) and FIG. 5 (which shows the front side of the base clip 150), as previously stated, after the shutter arrangement 110 is fully assembled, it gets snapped into engagement with the corresponding receptacle cover 4A in order to fixedly couple the base clip 150 to the receptacle cover 4A. The shutter 112 comprises two side rails 121 that bound the shutter 112 in the height dimension 1015. On the rear side 122 of the shutter 112, each of the side rails 121 comprises a fulcrum 123, and the fulcrum 123 engages the front side of a main body 151 of the base clip 150 when the shutter arrangement 110 is assembled. When an object such as a standard electrical plug or a non-plug object is inserted into some combination of the hot slot 5 and neutral slot 7 of the receptacle cover 4A, the object first engages the front side 124 of the shutter 112, and the shutter 112 is able to rotate and/or slide in the width dimension 1010 relative to the main body 151 of the base clip 150 due to the formation of the fulcrum 123 in the shutter 112 and due to the spring 114 being able to compress and expand. The extent to which the shutter 112 rotates and/or slides depends on whether the object engaging the front side 124 is a plug or non-plug object, as explained hereafter.

Continuing to refer to FIGS. 2-3, when a standard electrical plug is inserted into the receptacle cover 4A in the electrical receptacle arrangement 100, the hot blade and the neutral blade of the electrical plug being the same length in the depth dimension 1005 causes the hot blade and the neutral blade to engage the front side 124 of the shutter 112 at the same time. This simultaneous engagement of the shutter’s front side 124 by the plug’s hot blade and neutral blade causes the shutter 112 to slide in the width dimension 1010 such that a hot opening 125 in the shutter 112 aligns with a hot opening 152 of the base clip 150 and such that a neutral opening 126 in the shutter 112 aligns with a neutral opening 153 of the base clip 150. When the hot openings 125, 152 align with one another and the neutral openings 126, 153 align with one another, the hot and neutral blades of the electrical plug are able to pass through the respective hot openings 125, 152 and neutral openings 126, 153 and make physical and electrical contact with the hot and neutral terminal assemblies 11, 13 (FIG. 1).

Still referring to FIGS. 2 and 3, when a non-plug object is inserted into the receptacle cover 4A in the electrical receptacle arrangement 100, there are a few different scenarios that can occur: the object may only be inserted into the hot slot 5 of the receptacle cover 4A; the object may only be inserted into the neutral slot 7 receptacle cover 4A; or the object may have two prongs of unequal length in the depth dimension 1005 such that either the prong in the hot slot 5 engages the shutter’s front side 124 before the prong in the neutral slot 7 does or the prong in the neutral slot 7 engages the shutter’s front side 124 before the prong in the hot slot 5 does. It is noted that when the hot prong is significantly longer than the neutral prong, the shutter is engaged by the hot prong in a manner similar to when the non-plug object has no neutral prong at all. Similarly, when the neutral prong is significantly longer than the hot prong, the shutter is engaged by the neutral prong in a manner similar to when the non-plug object has no hot prong at all. While the specific degree, direction, and orientation of rotation and/or sliding of the shutter 112 that occurs varies somewhat between each of the aforementioned scenarios involving a non-plug object, the overall result is the same. The overall result is that the engagement of the shutter’s front side 124 by the object through only the hot slot 5 or through only the neutral slot 7 causes the shutter 112 to move far enough in the width dimension 1010 such that the solid portions of the shutter 112 obstruct access to the hot and neutral openings 152, 153 of the base clip 150. That is, the shutter 112 slides far enough in the width dimension 1010 such that the shutter’s hot and neutral openings 125, 126 do not align with the base clip’s hot and neutral openings 152, 153 in the width dimension 1010, and the non-plug object is prevented from making physical and electrical contact with the hot and neutral terminal assemblies 11, 13 (FIG. 1), because the non-plug object instead makes physical contact with the solid portions of the shutter 112.

As previously noted, FIG. 4 shows the rear side of the base clip 150 (also visible in FIGS. 2-3) and FIG. 5 shows the front side of the base clip 150 of shutter assembly 100. The front side of base clip 150 is symmetrical relative to the height dimension 1015. In particular, the front side of the base clip 150 has reflective symmetry about a central axis 1021 that is linear in the width dimension 1010. While the entire rear side of the base clip 150 is not perfectly symmetrical relative to the height dimension 1015, the central axis 1021 represents the midline of the main body 151 relative to the height dimension 1015. Orientation or movement away from the central axis 1021 is referred to hereinafter using the term “lateral” and is denoted by the arrows numbered 1023 in the figures. Orientation or movement toward the central axis 1021 is referred to hereinafter using the term “medial” and is denoted by the arrows numbered 1025 in the figures.

As previously noted, the base clip 150 comprises a main body 151 that includes a hot opening 152 and a neutral opening 153, the hot and neutral openings 152, 153 being structured to respectively align with the hot and neutral slots 5, 7 of the individual receptacle cover 4A when a standard plug object engages the shutter 112 of the fully assembled electrical receptacle arrangement 100. A pair of protrusions including a first stopper 154A and a second stopper 154B are formed on the front side of base clip 150 and extend a distance X in the frontward direction 1001 from the main body 151. The first and second stoppers 154A, 154B obstruct the movement of the shutter 112 past a certain point in the width dimension 1010, which ensures that the solid portions of the shutter 112 obstruct access to the hot and neutral openings 152, 153 of the base clip 150 when a non-plug object is inserted into the receptacle cover 4A.

Continuing to refer to FIGS. 4-5, the base clip includes a wedge arm 154 and a U-ended arm 155 formed on opposite sides of the main body 151 in the width dimension 1010. Both the wedge arm 154 and the U-ended arm 155 extend further frontward 1001 than the main body 151 in the depth dimension 1005. The U-ended arm 155 includes a U-shaped formation 156 disposed at the rear end of the U-shaped arm 155, visible in FIG. 4, with the U-shaped formation being disposed further rearward 1002 than the main body 151.

The main body 151 comprises a front planar surface 157 that is planar relative to the width and height dimensions 1010 and 1015. The wedge arm 154 is bounded in the height dimension 1015 by two tapered walls 158 that are spaced apart from one another in the height dimension 1015. Relative to the width dimension 1010, each tapered wall 158 is widest at its rear-most end and thinnest at its front-most end, due to the tapered wall 158 having a sloped edge 159 that is non-orthogonal to the main body’s front planar surface 157 and non-orthogonal to a straight edge 160 that is orthogonal to the front planar surface 157. The wedge arm 154 also has a back wall 161 that is planar and orthogonal to the front planar surface 157, the back wall 161 being disposed opposite the sloped edge 159. The back wall 161 shares the straight edge 160 with each of the tapered walls 158 and is bounded in the height dimension 1015 by the two straight edges 160.

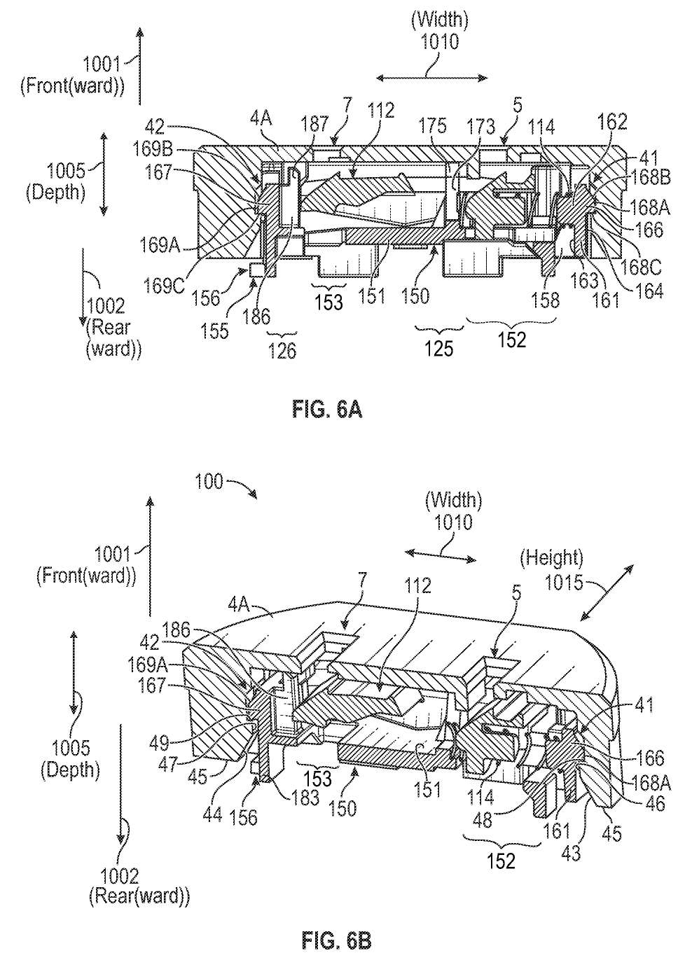

A spring mount 162 is formed on the interior surface 163 (numbered in FIG. 6A) of the back wall 161, the interior surface 163 being the surface that faces the U-ended arm 155. The spring mount 162 may be easiest to discern in FIGS. 6A-6B, as only a small portion of the spring mount 162 is visible in the view shown in FIG. 5. The exterior surface 164 (numbered in FIG. 6A) of the back wall 161 is the surface disposed opposite the interior surface 163. As can be seen in FIGS. 3 and 6A-6B, when the shutter arrangement 110 is assembled, the spring 114 is mounted at one end to the base clip’s spring mount 162 and is mounted at the other end to a spring mount 127 (numbered in FIG. 3) of the shutter 112. FIGS. 6A-6B show the default state of the shutter arrangement 110, the default state being the state assumed when there is no external object engaging the shutter 112, i.e. when there is no plug or non-plug object inserted into the receptacle cover 4A. It will be appreciated that because the base clip 150 remains fixed in place relative to the receptacle cover 4A and because only the shutter 112 can move relative to the receptacle cover when the shutter arrangement 110 is installed in the receptacle cover, the state of the shutter arrangement 110 is determined by the state of the shutter 112. It should be noted from FIGS. 6A-6B that the solid portions of the shutter 112 obstruct access to the base clip’s hot and neutral openings 152, 153 from the receptacle cover’s hot and neutral openings 5, 7 when the shutter 112 is in the default state. The coupling of the spring 114 to the two spring mounts 162 and 127 enables the spring 114 to bias the shutter 112 to the default position when no external object is inserted into the receptacle cover 4A, and also assists with rotation and sliding of the shutter 112 when a plug or non-plug object engages the shutter 112 after being inserted into the receptacle cover 4A.

A first snap lock protrusion 166 extends from the front end of the back wall 161 in the width dimension 1010. A second snap lock protrusion 167 (visible in FIG. 3 but not visible in FIGS. 4-5) extends from the front end of the U-ended arm 155 in the depth dimension 1010. The snap lock protrusion 166 can also be referred to as the “wedge arm snap lock protrusion 166” and the snap lock protrusion 167 can also be referred to as the “U-ended arm snap lock protrusion 167”. Both of the snap lock protrusions 166, 167 extend away from the main body 151 relative to the width dimension 1010. The first snap lock protrusion 166 is structured to engage with a first depression 41 (FIGS. 6A-6B) formed in the rear side of the individual receptacle cover 4A and the second snap lock protrusion 167 is structured to engage with a second depression 42 (FIGS. 6A-6B) formed in the rear side of the individual receptacle cover 4A in order to fixedly couple the base clip 150 (and the entire shutter arrangement 110) to the receptacle cover 4A when the shutter arrangement 110 is snap fit into the receptacle cover 4A, as depicted in FIG. 2.

The base clip 150 further comprises a shutter coupling mechanism 170 (numbered in FIG. 5) that includes a coupling base 171 and a pair of coupling legs 173. The coupling base 171 extends from the main body 151 in the width dimension 1010 such that the coupling base 171 is positioned within the hot opening 152. The coupling base 171 extends between the coupling legs 173 in the height dimension 1015 and the coupling legs 173 extend in the frontward direction 1001 from the coupling base 171. Each of the coupling legs 173 is equidistant from the central axis 1021. The front end of each of the coupling legs 173 terminates in a foot 175. For each coupling leg 173, the foot 175 is the front-most portion of the coupling leg 173. The foot 175 is also the portion of the coupling leg 173 that extends furthest in the height dimension 1015 away from the central axis 1021.

Each foot 175 comprises a front surface 176, a sloped surface 177, a lateral surface 178, and a hook surface 179. The front surface 176 is the front-most portion of the coupling leg 173. The sloped surface 177 extends from the front surface 176 in the height dimension 1015 away from the central axis 1021 while also extending slightly rearward 1002 from the front surface 176. The lateral surface 178 extends rearward 1002 from the sloped surface 177. In one exemplary embodiment, the lateral surface 178 is orthogonal to the main body’s front planar surface 157. The lateral surface 178 is the portion of the foot 175 and the portion of the coupling leg 173 that is disposed furthest from the central axis 1021. The hook surface 179 is curved and extends from the lateral surface 178 in the height dimension 1015 toward the central axis 1021. The hook surface 179 is continuous with and extends into a lateral side 181 of the coupling leg 173. The lateral side 181 of the coupling leg 173 is planar and extends rearward 1002 from the hook surface 179 to the coupling base 171. Stated alternatively, the lateral side 181 of the coupling leg extends frontward 1001 from the coupling base 171 to the hook surface 179. In one exemplary embodiment, the lateral side 181 is orthogonal to the main body’s front planar surface 157.

Referring to FIG. 5 in conjunction with FIG. 3, it is noted that the design of the feet 175 is advantageous for automated assembly of the shutter arrangement 110. For simplicity and brevity, the assembly process of the shutter arrangement 110 is described based on the premise that the shutter 112 is held stationary while the base clip 150 is moved toward the shutter 112, but it should be understood that the base clip 150 and shutter 112 can instead be simultaneously moved toward one another. Referring to FIG. 3, the base clip’s coupling legs 173 must be positioned to align with the shutter’s hot opening 125 in the width and height dimensions 1010, 1015, and the front side of the base clip 150 must be moved frontward 1001 toward the rear side 122 of the shutter 112. As the base clip 150 moves frontward 1001 toward the shutter 112, the coupling legs 173 contact the shutter’s rear side 122, and specifically, the sloped surfaces 177 of the base clip’s feet 175 engage the rear side of the shutter’s side rails 121. The base clip 150 is produced from a material that has at least some degree of flexibility, and as force is continually applied frontward 1001 on the base clip 150 after the base clip’s feet 175 have engaged the rear side of the side rails 121, the base clip’s feet 175 maintain engagement with the shutter 112 as the base clip’s coupling legs 173 are pushed medially 1025 toward the central axis 1021 due to the rearward 1002 sloping of the foot’s sloped surface 177 relative to the front surface 176. The base clip’s coupling legs 173 continue to move medially 1025 until the lateral surface 178 of each coupling leg 173 engages an interior surface 128 of the adjacent side rail 121 of the shutter 112 (only one interior surface 128 is visible and numbered in FIG. 3).

Continuing to refer to FIG. 5 in conjunction with FIG. 3, the medial 1025 movement of the base clip’s coupling legs 173 ceases once the base clip feet’s lateral surfaces 178 have cleared the rear side of the side rails 121 in the height dimension 1015 and are engaging the shutter’s side rail interior surfaces 128, and the base clip 150 continues to move frontward 1001 until the lateral surfaces 178 are disposed entirely frontward 1001 of the front side of the side rails 121. Once the base clip’s lateral surfaces 178 are disposed entirely frontward 1001 of the front side of the shutter’s side rails 121, each of the base clip’s coupling legs 173 moves as far laterally 1025 as it can toward its default position, resulting in each coupling leg’s lateral side 181 engaging the interior surface 128 of the adjacent shutter side rail 121. This lateral movement of the base clip’s coupling legs 173 results in each coupling leg 173 exerting a pushing force in the lateral direction 1023 against the adjacent shutter side rail 121.

When the base clip’s lateral surfaces 178 are disposed entirely frontward 1001 of the front side of the shutter’s side rails 121, the lateral 1023 movement of the base clip’s coupling legs 173 when returning to their default positions results in the shutter 112 being coupled to the base clip 150, as the lateral 1023 force exerted by of the base clip’s coupling legs 173 against the shutter’s side rails 121 causes the hook surface 179 of each coupling leg 173 to overlap with the adjacent shutter side rail 121 in the height dimension 1015. The overlap of each hook surface 179 and the adjacent side rail 121 in the height dimension 1015 results in the hook surface 179 exerting a pushing force in the rearward direction 1002 against the front surface of the side rail 121. As such, in order to uncouple the base clip 150 from the shutter 112, a pushing force must be exerted against the base clip’s coupling legs 173 in the medial direction 1023 so that each coupling leg’s lateral surface 178 is disposed medially 1023 relative to the adjacent side rail’s interior surface 128 (i.e. such that the foot 175 no longer overlaps with the side rail 121 in the height dimension 1015) so that the base clip 150 can then be pulled rearward away from the shutter 112 without the shutter 112 obstructing the movement of the base clip’s coupling legs 173. When the base clip 150 is coupled to the shutter 112, one end of the spring 114 can be mounted to the base clip’s spring mount 162 and the other end of the spring 114 can be mounted to the shutter’s spring mount 127. It is noted that the base clip 150 is proportioned to ensure that the shutter’s fulcrums 123 engage the base clip’s main body 151 once the base clip 150 and shutter 112 are coupled to one another, as shown in FIG. 2.

Referring once more to FIGS. 4-5, the portion of the U-shaped arm 155 that is disposed rearward 1002 relative to the base clip’s main body 151 and comprises the U-shaped formation 156 (primarily visible in FIG. 4) can be referred to as the rear portion of the U-shaped arm 155, while the portion of the U-shaped arm 155 that is disposed frontward 1001 relative to the base clip’s main body 151 (primarily visible in FIG. 5) can be referred to as the front portion of the U-shaped arm 155. The U-shaped arm 155 comprises a base wall 183 that is planar and extends from the front end to the rear end of the U-shaped arm 155. The rear end of the base wall 183 forms the base of the U-shaped formation 156. The base wall 183 has an interior surface 184 that faces the wedge arm 154, and the U-shaped arm 155 comprises a number of fins 185 (two fins 185 being shown in the figures) that extend from the interior surface 184 in the width dimension 1010 toward the neutral opening 153. Each fin 185 comprises a base portion 186 and an extension 187. The base portion 186 is flush with the front-most end of the base wall 183 in the depth dimension 1005 and the extension 187 extends further frontward 1001 than the base portion 186.

In FIGS. 6A-6B, it can be seen that the fins 185 (and specifically the base portions 186) obstruct the movement of the shutter 112 past a certain point in the width dimension 1010, which assists with causing the shutter 112 to rotate when an object is inserted into receptacle cover 4A. In particular, the shutter arrangement 110 is structured such that insertion of an object into the receptacle cover 4A would cause linear movement of the shutter 112 in the width dimension 1010 if the fins 185 were not present, but the obstruction to movement in the width dimension 1010 presented by the fins 185 forces the shutter 112 to rotate instead of moving in a purely linear path.

As numbered in FIGS. 6A-6B, the wedge arm snap lock protrusion 166 comprises an outer edge surface 168A and the U-ended arm snap lock protrusion 167 comprises an outer edge surface 169A. The outer edge surface 168A of the wedge arm snap lock protrusion 166 is planar relative to the depth dimension 1005 and is the outermost surface of the wedge arm snap lock protrusion 166 in the width dimension 1010, i.e. the outer edge surface 168A is the surface of the wedge arm snap lock protrusion 166 that is disposed furthest from the base clip’s main body 151 in the width dimension 1010. The outer edge surface 169A of the U-ended arm snap lock protrusion 167 is planar relative to the depth dimension 1005 and is the outermost surface of the U-ended arm snap lock protrusion 167 in the width dimension 1010, i.e. the outer edge surface 169A is the surface of the U-ended arm snap lock protrusion 167 that is disposed furthest from the base clip’s main body 151 in the width dimension 1010.

As numbered in FIG. 6A, the wedge arm snap lock protrusion 166 also comprises a tapering surface 168B and the U-ended arm snap lock protrusion 167 comprises a tapering surface 169B. Both tapering surfaces 168B, 169B are adjacent to and disposed frontward 1001 of the respective outer edge surfaces 168A, 169A. Both tapering surfaces 168B, 169B are non-orthogonal relative to the depth dimension 1005, such that the front-most end of each tapering surface 168B, 169B is disposed closer to the main body 151 in the width dimension 1010 than the rear-most end of each tapering surface 168B, 169B is.

As numbered in FIG. 6A, the wedge arm snap lock protrusion 166 further comprises a snap engagement lip 168C and the U-ended arm snap lock protrusion 167 comprises a snap engagement lip 169C. Both snap engagement lips 168C, 169C are surfaces adjacent to and disposed rearward 1002 of the respective outer edge surfaces 168A, 169A. Both snap engagement lips 168C, 169C are orthogonal relative to the depth dimension 1005.

Also labeled in FIG. 6B are a first guiding edge 43 and a second guiding edge 44 of the receptacle cover 4A. Both guiding edges 43, 44 extend in the frontward direction 1001 from the rearmost edge 45 of the receptacle cover 4A. Both guiding edges 43, 44 also extend from the rearmost edge 45 in the width dimension 1010 toward the hot and neutral slots 5, 7. There is an opening in the receptacle cover 4A between the guiding edges 43, 44, and the opening is widest where each of the guiding edges 43, 44 is adjacent to the rearmost edge 45. The extension of the guiding edges 43, 44 from the rearmost edge 45 in the frontward direction 1001 and in the width dimension 1010 results in the opening between the guiding edges 43, 44 narrowing in the frontward direction 1001. The front end of the guiding edge 43 is adjacent to a compressing surface 46, and the front end of the guiding edge 44 is adjacent to a compressing surface 47. Both the compressing surface 46 and the compressing surface 47 are planar relative to the depth dimension 1005. The front end of the compressing surface 46 is adjacent to a shelf 48, and the front end of the compressing surface 47 is adjacent to a shelf 49. Both the shelf 48 and the shelf 49 are planar relative to the width and height dimensions 1010, 1015.

As previously noted, after the shutter arrangement 110 is assembled, the shutter arrangement 110 can be snap fit into the receptacle cover 4A. To do so, the shutter arrangement 110 must be positioned so that the shutter’s front side 124 faces toward the rear side of the receptacle cover 4A, and so that the base clip’s tapering surfaces 168B, 169B face toward the receptacle cover’s guiding edges 43, 44, which is how the one shutter arrangement 110 in FIG. 2 not yet coupled to the receptacle cover 4A is positioned. The shutter arrangement 110 must be moved frontward 1001 toward the receptacle cover 4A until the base clip’s tapering surface 168B engages the receptacle cover’s guiding edge 43 and the base clip’s tapering surface 169B engages the receptacle cover’s guiding edge 44. After the tapering surfaces 168B, 169B engage the receptacle cover’s guiding edges 43, 44, the base clip 150 must continue to be pushed frontward 1001. As previously noted in the discussion of the automated assembly of the shutter arrangement 110, the base clip 150 is produced from a material that has at least some degree of flexibility, and as the shutter arrangement 110 continues to be pushed frontward 1001, the wedge arm 154 and the U-ended arm 155 get pushed slightly inward in the width dimension 1010 toward the main body 151. The inward movement of the wedge arm 154 and the U-ended arm 155 toward the main body 151 continues until the outer edge surface 168A is disposed more inward (i.e. closer toward the main body 151) than the compressing surface 46 and the outer edge surface 169A is disposed more inward (i.e. closer toward the main body 151) than the compressing surface 47. At this point, the outer edge surface 168A slides frontward 1001 into engagement with the compressing surface 46 and the outer edge surface 169A slides frontward 1001 into engagement with the compressing surface 47.

As the shutter arrangement 110 continues to be pushed frontward 1001, the base clip’s outer edge surfaces 168A, 169A slide against the compressing surfaces 46, 47 until the rear end of the outer edge surface 168A is more frontward 1001 than the front end of the compressing surface 46 and the rear end of the outer edge surface 169A is more frontward 1001 than the front end of the compressing surface 47. At this point, the compressing force exerted by the compressing surfaces 46, 47 on the base clip’s the wedge arm 154 via the outer edge surface 168A and on the base clip’s U-ended arm 155 via the outer edge surface 169A is removed, and the wedge arm 154 and U-ended arm 155 expand outward (i.e. away from the main body 151) in the width dimension 1010 back to their default positions. As the wedge arm 154 expands, the snap engagement lip 168C slides into engagement with the shelf 48, and as the U-ended arm 155 expands, the snap engagement lip 169C slides into engagement with the shelf 49. When the wedge arm 154 is fully expanded to its default state, the outer edge surface 168A is disposed further outward (i.e. away from the main body 151) than the compressing surface 46. When the U-ended arm 155 is fully expanded to its default state, the outer edge surface 169A is disposed further outward (i.e. away from the main body 151) than the compressing surface 47.

The engagement of the snap engagement lip 168C with the shelf 48 and the engagement of the snap engagement lip 169C with the shelf 49 couples the shutter arrangement 110 to the receptacle cover 4A by fixedly coupling the base clip 150 to the receptacle cover 4A while the shutter 112 and spring 114 are movably coupled to the base clip 150 between the base clip 150 and receptacle cover 4A. It will be appreciated the design of the improved base clip 150 makes automated assembly of the electrical receptacle arrangement 100 relatively easy, as each shutter assembly 110 simply needs to be correctly aligned with the rear side of a receptacle cover 4A and then pushed with sufficient force in the frontward direction 1001 to snap the shutter assembly 110 into engagement with the receptacle cover 4A as detailed above.

It will be further appreciated that the snap lock protrusions 166, 167 of the base clip 150 securely couple the base clip 150 to the receptacle cover 4A, because in order to uncouple the base clip 150 (and the overall shutter arrangement 110) from the receptacle cover 4A, a compression force must be exerted inward (i.e. toward the base clip’s main body 151) in the width dimension 1010 against the base clip’s wedge arm 164 and U-ended arm 155 so that the wedge arm’s outer edge surface 168A is disposed further inward than the compressing surface 46 and so that the U-ended arm’s outer edge surface 169A is disposed further inward than the compressing surface 47. This compression force must be applied so that the base clip 150 can be pulled rearward 1002 away from the receptacle cover 4A without the shelves 48, 49 obstructing the rearward 1002 movement of the base clip’s snap lock protrusions 166, 167.

Reference is now made to FIGS. 7A-7B, which as mentioned briefly earlier herein, show a shutter arrangement 210 that includes a base clip 250, in accordance with another exemplary embodiment of the disclosed concept. Similar to the shutter arrangement 110, each shutter arrangement 210 comprises the shutter 112 and the spring 114, but the shutter arrangement 210 comprises a base clip 250 instead of the base clip 150. As depicted in FIGS. 7A-7B, each shutter arrangement 210 is structured to be coupled to the rear side of one of the individual receptacle covers 4B. The shutter arrangement 210 functions similarly to the shutter arrangement 110 to ensure that only a plug whose hot blade and neutral blade are the same length (with some tolerance for small variations) can make physical contact with the hot terminal assembly 11 and the neutral terminal assembly 13 when inserted into the hot slot 5 and neutral slot 7 of the outlet cover assembly 1 (FIG. 1).

The shutter 112, the spring 114, and the base clip 250 form the shutter arrangement 210 when coupled to the receptacle cover 4B, and the base clip 250 comprises snap fit features that enable it to be fixedly coupled to the receptacle cover 4B. However, in contrast with the base clip 150 of the shutter arrangement 110, the base clip 250 does not get coupled to the shutter 112 or the spring 114, and the shutter arrangement 210 is not structured to be fully assembled prior to being coupled to the receptacle cover 4B. Instead, the shutter arrangement 210 must be coupled to the receptacle cover 4B in segments. Specifically, the shutter 112 and spring 114 must be coupled to the receptacle cover 4B prior to the base clip 250 getting coupled to the receptacle cover 4B (denoted in FIG. 7A with the label “Stage 1”), as the base clip 250 does not include a spring mount (in contrast with the base clip 150, which includes the spring mount 162). As can be discerned from comparing FIG. 7B to FIG. 7A, during the assembly process for the electrical receptacle arrangement 200, the shutter 112 and spring 114 get aligned with and then seated into the rear side of the receptacle cover 4B. Afterward, as depicted in FIG. 7B and denoted in FIG. 7B with the label “Stage 2”, the base clip 250 gets aligned with the rear side of the receptacle cover 4B so that a first end of the base clip 250 can be inserted into a locked configuration with the receptacle cover 4B (as indicated by the arrow labeled “LOCK”) prior to a second end of the base clip 250 being snap fit into the receptacle cover 4B (as indicated by the arrow labeled “SNAP”), in order to fixedly couple the base clip 250 to the receptacle cover 4B, with the shutter 112 and spring 114 being disposed between the receptacle cover 4B and the base clip 250. That is, coupling the base clip 250 to the receptacle cover 4B ensures that the shutter 112 and spring 114 remain coupled to the receptacle cover 4B as well.

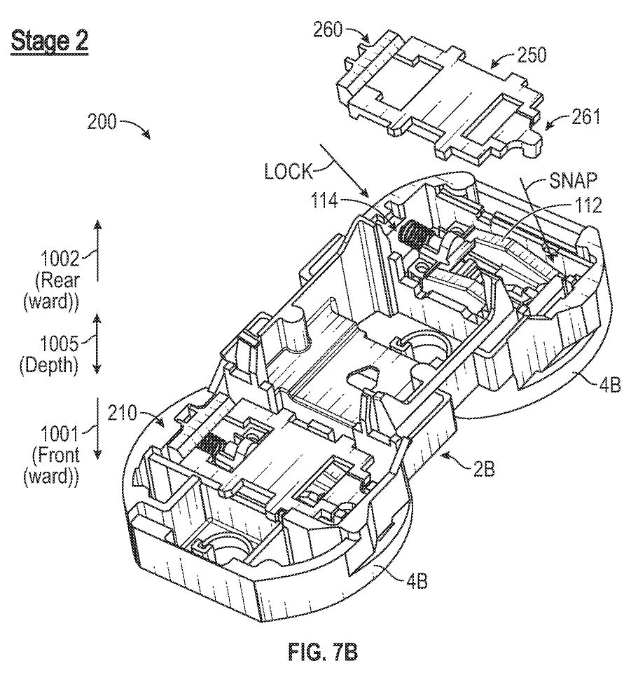

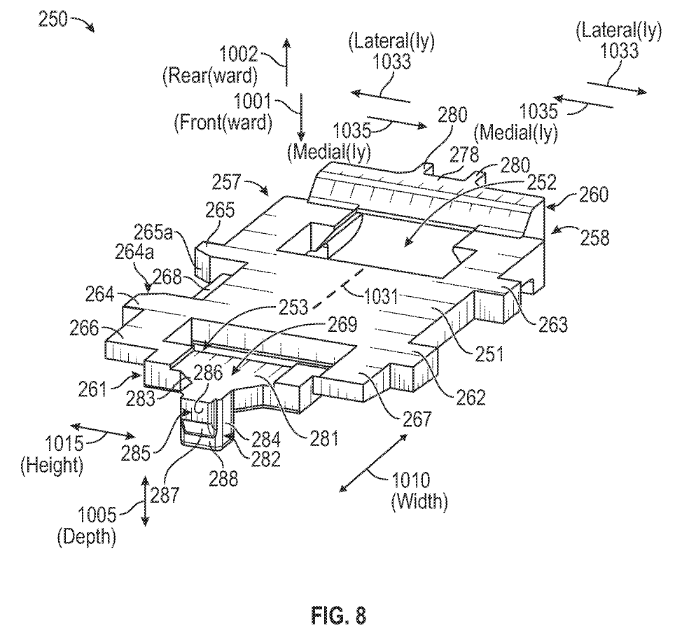

FIG. 8 shows the rear side of the base clip 250 (the rear side of the base clip 250 also being visible in FIGS. 7A-7B) and FIG. 9 shows the front side of the base clip 250. The base clip 250 comprises a main body 251 that includes a hot opening 252 and a neutral opening 253, the hot and neutral openings 252, 253 being structured to align with the hot and neutral slots 5,7, respectively, of a receptacle cover 4B when electrical receptacle arrangement 200 is fully assembled. The general mechanics of how the shutter arrangement 210 prevents any non-plug object from accessing the live electrical terminal assemblies 11, 13 when coupled to the rear side of the receptacle cover 4B are similar to those of the shutter arrangement 110. That is, the shutter arrangement 210 functions similarly to the shutter arrangement 110 to ensure that only a plug whose hot blade and neutral blade are the same length (with some tolerance for small variations) can make physical contact with the hot terminal assembly 11 and the neutral terminal assembly 13 when inserted into the hot slot 5 and neutral slot 7 of the outlet cover assembly 1 (FIG. 1).

Referring to FIG. 3 (which shows an enlarged view of the shutter 112) in conjunction with FIGS. 8 and 9, when an object such as a standard electrical plug or a non-plug object is inserted into some combination of the hot slot 5 and neutral slot 7 of the receptacle cover 4B, the object first engages the front side 124 of the shutter 112, and the shutter 112 is able to rotate and/or slide in the width dimension 1010 relative to the a main body 251 of the base clip 250 due to the formation of the fulcrum 123 in the shutter 112 and due to the spring 114 being able to compress and expand. The extent to which the shutter 112 rotates and/or slides depends on whether the object engaging the front side 124 is a plug or non-plug object. When a standard electrical plug is inserted into the receptacle cover 4B in the electrical receptacle arrangement 200, the hot blade and the neutral blade engage the front side 124 of the shutter 112 at the same time, causing the shutter 112 to slide in the width dimension 1010 such that a hot opening 125 in the shutter 112 aligns with the hot opening 252 of the base clip 250 and such that a neutral opening 126 in the shutter 112 aligns with the neutral opening 253 of the base clip 250. When the hot openings 125, 252 align with one another and the neutral openings 126, 253 align with one another, the hot and neutral blades of the electrical plug are able to pass through the respective hot openings 125, 252 and neutral openings 126, 253 and make physical and electrical contact with the hot and neutral terminal assemblies 11, 13 (FIG. 1).

When a non-plug object is inserted into the receptacle cover 4B in the electrical receptacle arrangement 100, the overall result is that the engagement of the shutter’s front side 124 by the object through only the hot slot 5 or through only the neutral slot 7 causes the shutter 112 to move far enough in the width dimension 1010 such that the solid portions of the shutter 112 obstruct access to the hot and neutral openings 252, 253 of the base clip 250. That is, the shutter 112 slides far enough in the width dimension 1010 such that the shutter’s hot and neutral openings 125, 126 do not align with the base clip’s hot and neutral openings 252, 253 in the width dimension 1010, and the non-plug object is prevented from making physical and electrical contact with the hot and neutral terminal assemblies 11, 13 (FIG. 1), because the non-plug object instead makes physical contact with the solid portions of the shutter 112.

Referring to FIG. 8 and FIG. 9, the features of the base clip 250 will now be discussed in more detail. A first stopper 256A and a second stopper 256B extending a distance X in the frontward direction from main body 251 are included on the front side of base clip 250 to stop the movement of the shutter 112 in the event that an object is inserted through only the hot slot 5 of an individual outlet cover 4B or in the event that the neutral prong of a plug is significantly shorter than the hot prong. The distance X that the first stopper 256A and second stopper 256B extend from main body 251 determines how much shorter a neutral prong can be relative to the hot prong while still enabling the plug prongs to successfully engage the shutter 112 in order to access the hot and neutral electrical terminals 11, 13 (FIG. 1).

The base clip 250 has a central axis 1031 that in linear in the width dimension 1010 and represents the midline of the main body 251 in the height dimension 1015. Orientation or movement away from the central axis 1031 is referred to hereinafter using the term “lateral” and is denoted by the arrows numbered 1033 in the figures. Orientation or movement toward the central axis 1031 is referred to hereinafter using the term “medial” and is denoted by the arrows numbered 1035 in the figures.

The base clip 250 comprises a first lateral side 257 disposed laterally 1033 from the central axis 1031 in a first direction and a second lateral side 258 disposed laterally 1033 from the central axis 1031 in a second direction that is opposite the first direction. The hot and neutral openings 252, 253 are formed in the main body 251 and extend between the first and second lateral sides 257, 258.

The front side (FIG. 8) of the base clip 250 includes several seating features, i.e. features that assist in correctly seating the base clip 250 in the rear side of the receptacle cover 4B during the automated process of assembling the electrical receptacle arrangement 200. Said seating features include: a lock arm 260, a snap fit arm 261, a first side arm 262, a second side arm 263, a first poka-yoke arm 264, a second poka-yoke arm 265, a first neutral border portion 266, and a second neutral border portion 267. Both neutral border portions 266, 267 border the neutral opening 253 in the height dimension 1015, with the first neutral border portion 266 being disposed laterally 1033 from the neutral opening 253 on a first side of the neutral opening 253, and the second neutral border portion 267 being disposed laterally 1033 from the neutral opening 253 on a second side of the neutral opening 253 disposed opposite the first side. Both neutral border portions 266, 267 extend in the with dimension 1010 between the main body 251 and the snap fit arm 261.

The poka-yoke arms 264, 265 are formed on the first lateral side 257 and the two side arms 262, 263 are formed on the second lateral side 258, such that the side arms 262, 263 extend laterally 1033 from the main body 251 in a first direction, while the poka-yoke arms 264, 265 extend laterally 1033 from the main body 251 in a second direction that is opposite the first direction. Exclusive of the side arms 262, 263 and the poka-yoke arms 264, 265, the base clip 250 has reflective symmetry about the central axis 1031.

The two poka-yoke arms 264, 265 are formed with angled edges for use as poka-yoke (i.e. error-proofing) devices to ensure that the base clip 250 is oriented in the correct direction when seated within the individual receptacle cover 4B during assembly. In particular, relative to a plane that lies in the width dimension 1010 and the height dimension 1015, the first lateral side 257 comprises edges that are either linear solely in the width dimension 1010 or linear solely in the height dimension 1015, with the exception of an angled edge 264A of the poke-yoke arm 264 and an angled edge 265A of the poke-yoke arm 265. That is, neither of the angled edges 264A, 265A are linear in either the width dimension 1010 or the height dimension 1015. This non-linearity of the angled edges 264A, 265A relative to both the width and height dimensions 1010, 1015 facilitates correct alignment of the base clip 250 with the rear side of the receptacle cover 4B, as the receptacle cover 4B comprises depressions having angled edges that correspond to the poka-yoke angled edges 264A, 265A (i.e. are also non-linear relative to both the width and height dimensions 1010, 1015), and thus are structured to seat the poka-yoke arms 264, 265.

As shown in FIG. 8, the rear side of the base clip 250 includes a first depression 268 disposed between the two poka-yoke arms 264, 265 and a second depression 269 formed on the rear side of the snap fit arm 261. The main body 251 is planar in a plane that lies in the width and height dimensions 1010, 1015 and is orthogonal to the depth dimension 1005. The first and second depressions 268, 269 are planar surfaces disposed in a plane that is parallel to the rear surface of the main body 251 such that the depressions 268, 269 are disposed more frontward 1001 than the rear surface of the main body 251. The first depression 268 prevents interference between the rear side of base clip 250 with the ground strap 15 (FIG. 1) in the fully assembled electrical receptacle arrangement 200, and the second depression 269 prevents interference between the rear side of base clip 250 with the neutral terminal assembly 13 (FIG. 1) in the fully assembled electrical receptacle arrangement 200.

The lock arm 260 will now be discussed, and a discussion of the snap fit arm 261 will follow. The lock arm 260 and snap fit arm 261 are the two features that fixedly couple the base clip 250 to the receptacle cover 4B and thus couple the entire shutter assembly 210 to the receptacle cover 4B. Referring to FIG. 9 to discuss the lock arm 260 and the front side of the base clip 250, it is noted that the first and second stoppers 256A, 256B are disposed laterally 1033 relative to the hot opening 252, with the first stopper 256A being disposed on the first lateral side 257 and the second stopper 256B being disposed on the second lateral side 258. A bench portion 271 of the lock arm 260 extends in the height dimension 1015 from the first stopper 256A to the second stopper 256B. The lock arm 260 further comprises a lock protrusion 272 that extends from the bench portion 271 in the width dimension 1010 away from the hot opening 252. The lock protrusion 272 comprises a solid block 273 that forms the front end of the lock protrusion 272, with the solid block 273 being disposed more frontward 1001 than the bench portion 271. A rectangular surface 274 of the solid block 273 is the front-most surface of the lock protrusion 272.

The lock protrusion 272 further comprises a U-shaped portion 275 that is continuous with the solid block 273 and is disposed rearward 1002 of the solid block 273. The U-shaped portion 275 comprises two different surfaces having a U-shaped cutout in two different planes. A first U-cutout surface 277 is visible in FIG. 9 and is planar in a plane that extends in the depth dimension 1005 and the height dimension 1015. A second U-cutout surface 278 is visible in FIG. 8 and is planar in a plane that extends in the width dimension 1010 and the height dimension 1015. The first and second U-cutout surfaces 277, 278 are orthogonal to one another and meet one another, resulting in the formation of a sloped surface 279 (numbered and visible in FIG. 9). The second U-cutout surface 278 comprises two fingers 280 (FIG. 8) on the rear side of the lock arm 260.

The snap fit arm 261 will now be discussed. Referring to the rear side of the base clip 250 shown in FIG. 8, it is noted that the depression 269 is formed on the rear side of the snap fit arm 261, and that the snap fit arm 261 forms one boundary of the neutral opening 253 in the width dimension 1010. Relative to the width dimension 1010, the snap fit arm 261 is disposed on a first side of the neutral opening 253 and the main body 251 is disposed on a second side of the neutral opening 253 opposite the first side. The snap fit arm 261 (including the depression 269) extends in the width dimension 1010 from the neutral opening 253 and away from the main body 251.

The snap fit arm 261 comprises a number of sections having different lengths in the height dimension 1015: a connecting section 281, a snap engagement section 282, and an angled section 283. The connecting section 281 extends in the height dimension 1015 between the neutral border portions 266, 267. The connecting section 281 is the section of the snap fit arm 261 having the greatest length in the height dimension 1015. The snap engagement section 282 is the section positioned furthest away from the main body 251 in the width dimension 1010 and is also the section of the snap fit arm 261 having the smallest length in the height dimension 1015. The angled section 283 extends in the height dimension 1010 between the connecting section 281 and the snap engagement section 282. The angled section 283 is shaped such that, relative to a plane extending in the width and height dimensions 1010, 1015, the angled section 283 is widest where it is adjacent to the connecting section 281 and narrowest where it is adjacent to the snap engagement section 282.

The features of the snap engagement section 282 are easiest to view in FIG. 8. The snap engagement section 282 comprises a box portion 284 and a snap fit protrusion 285 that extends from the box portion 284 in the width dimension 1010 away from the main body 251. A first side of the box portion 284 is adjacent to the angled section 283 and the snap fit protrusion 285 is adjacent to a second side of the box portion 284 disposed opposite the first side. The snap fit protrusion 285 comprises a protrusion straight wall 286 and a protrusion sloped wall 287. The protrusion straight wall 286 extends from the depression 269 in the frontward direction 1001 and is planar in the depth and height dimensions 1005, 1015. The protrusion sloped wall 287 is planar in a plane that does not lie in any of the depth, width, or height dimensions 1005, 1010, 1015. The box portion 284 comprises a box portion straight wall 288 that is planar in the depth and height dimensions 1005, 1015 and that is the surface of the box portion 284 disposed furthest from the main body 251. The protrusion straight wall 286 is disposed parallel to the box portion straight wall 288. The front-most edge of the protrusion sloped wall 287 is disposed rearward of the front edge of the box portion straight wall 289.

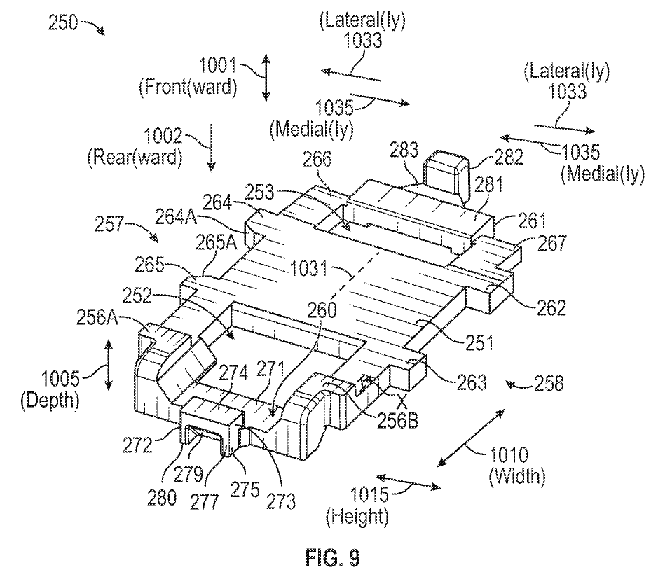

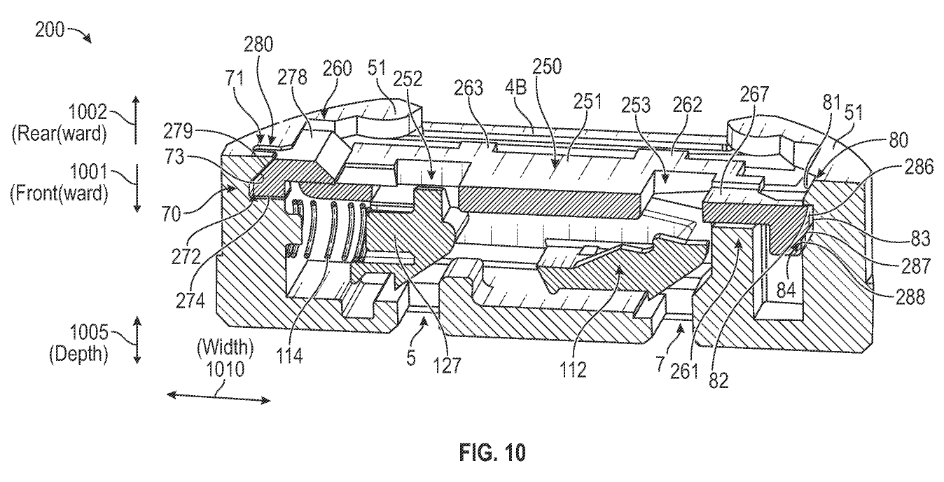

Reference is now made to FIG. 10 with additional reference to FIG. 11 to discuss how the features of the base clip 250 facilitate coupling of the base clip 250 to the receptacle cover 4B during automated assembly of the electrical receptacle arrangement 200. The receptacle cover 4B comprises a lock insertion opening 70 (see FIG. 11 for a non-sectional view of the lock insertion opening 70) that is structured to receive the lock arm 260 and a snap fit opening 80 (see FIG. 11 for a non-sectional view of the snap fit opening 80) structured to receive the snap fit arm 261 in order to fixedly couple the base clip 250 to the receptacle cover 4B. After the shutter 112 and spring 114 have been seated within and coupled to the rear side of the receptacle cover 4B, the base clip 250 gets coupled to the receptacle cover 4B by first inserting the base clip’s lock arm 260 into the receptacle cover’s lock insertion opening 70 and then snap fitting the base clip’s snap fit arm 261 into the receptacle cover’s snap fit opening 80.

Referring first to the receptacle cover’s lock insertion opening 70, the lock insertion opening 70 includes two finger openings 71 formed in a rear-most surface 51 of the receptacle cover 4B. Each of the finger openings 71 is structured to receive one finger 280 of the base clip 250. The lock insertion opening 70 further includes a cubby space 72 (FIG. 11) that is continuous with and extends between the two finger openings 71 in the height dimension 1015. An overhang 73 is formed between and separates the two finger openings 71. From the rear-most surface 51, the overhang 73 extends in the frontward direction 1001 and also extends in the width dimension 1010, causing the overhang 73 to be sloped.

In order to couple the base clip 250 to the receptacle cover 4B, the base clip 250 first needs to be positioned for insertion of the lock protrusion 272 into the lock insertion opening 70. The base clip 250 should initially be tipped slightly relative to the horizontal position shown in FIG. 10 so that the snap fit arm 261 is positioned somewhat rearward 1002 relative to the lock arm 260. Next, the fingers 280 should be aligned with the finger openings 71 in the height dimension 1015. The base clip 205 can then be pushed in the width dimension 1010 toward the finger openings 71 so that the fingers 280 slide into the finger openings 71 while the snap fit arm 260 is moved frontward 1001, which enables the sloped surface 279 on the lock arm 260 to move underneath the overhang 73 and into the cubby space 72 of the receptacle cover 4B. As shown in FIG. 10, the overhang 73 is structured to engage the sloped surface 279 when the lock arm 260 is inserted into the lock insertion opening 70. It will be appreciated that, because the overhang 73 overlaps with the base clip’s sloped surface 279 in the width dimension 1010 when the lock arm 260 is inserted into the lock insertion opening 70, the lock arm 260 will remain locked into the receptacle cover 4B when a pulling force is exerted on the base clip 250 solely in the rearward direction 1002, because the overhang 73 directly obstructs rearward 1002 movement of the sloped surface 279 and of the lock protrusion 272 as a whole.

The receptacle cover’s snap fit opening 80 will now be detailed. The snap fit opening 80 is formed in the rear-most surface 51 and extends frontward 1001. At the rear-most surface 51, the snap fit opening 80 is slightly longer than the base clip’s box portion 284 in the width dimension 1015. A guiding wall 81 extends from the rear-most surface 51 in the frontward direction 1001 and slightly in the width dimension 1010 toward the neutral opening 7. The slight extension of the guiding wall 81 in the width dimension 1010 causes the guiding wall 81 to be sloped relative to the depth and width dimensions 1005, 1010. The front end of the guiding wall 81 ends where it meets a snap fit ledge 82. The snap fit ledge 82 is planar in a plane that lies in the width and height dimensions 1010, 1015. The snap fit ledge 82 extends in the width dimension 1010 from the guiding wall 81 away from the neutral opening 7 to meet a notch wall 83. The notch wall 83 is planar in a plane that lies in the depth and height dimensions 1005, 1015. A snap fit depression 84 is formed by the meeting of the snap fit ledge 82 and the notch wall 83, and the snap fit protrusion 285 gets snap fitted into the snap fit depression 84 in order to complete the coupling of the base clip 250 to the receptacle cover 4B.

After the base clip’s lock arm 260 has been inserted into the receptacle cover’s lock arm insertion opening 70, the base clip’s snap fit arm 261 is disposed such that the protrusion sloped wall 287 rests against the receptacle cover’s guiding wall 81. Exerting frontward 1001 pressure on the snap fit arm 261 causes the protrusion sloped wall 287 to engage the guiding wall 81, and the sloping of the protrusion sloped wall 287 and of the guiding wall 81 causes the protrusion sloped wall 287 to slide along the guiding wall 81 in the frontward 1001 direction and in the width dimension 1010 toward the neutral opening 7, such that the snap fit arm 261 compresses slightly toward the base clip’s main body 251. It will be appreciated that the snap fit arm 261 is able to compress because the base clip 250 is produced from a material that has at least some degree of flexibility. Once the protrusion sloped wall 287 has slid far enough that the protrusion straight wall 286 has cleared the guiding wall 81 in the width dimension 1010, the snap fit arm 261 moves frontward 1001 until the base clip’s depression 267 is frontward 1001 of the receptacle cover’s snap fit ledge 82. Once the depression 267 is frontward 1001 of the snap fit ledge 82, the snap fit arm 261 expands back to its default state, such that the protrusion straight wall 286 is adjacent to the notch wall 83 (as shown in FIG. 10), completing the process of coupling the base clip 250 to the receptacle cover 4B. In this state, the base clip’s depression 267 overlaps with the snap fit ledge 82 in the width dimension 1010 such that the snap fit ledge 82 prevents rearward 1002 movement of the base clip 250.

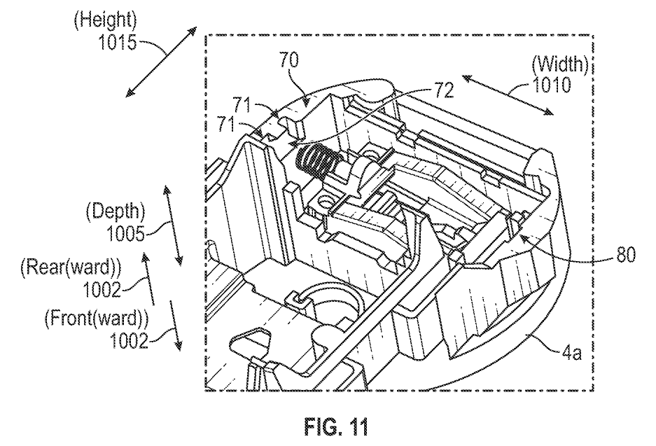

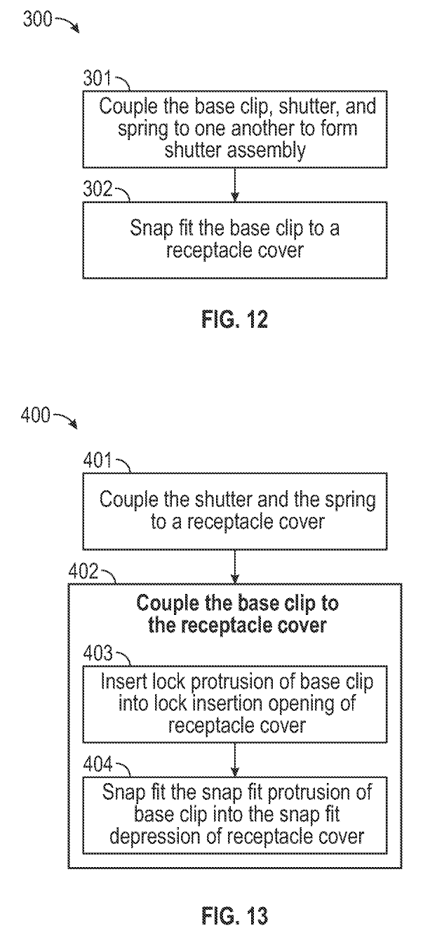

It should be appreciated that the advantageous structures of the base clips 150, 250 are advantageous because their snap fit coupling features facilitate improved automated processes for assembling each of the electrical receptacle arrangements 100, 200. To that end, FIG. 12 is a flow chart for a method 300 that can be employed to assemble the electrical receptacle arrangement 100 that includes the base clip 150, in accordance with an exemplary embodiment of the disclosed concept. At step 301 of the method 300, the base clip 150 gets coupled to the shutter 112 and to the spring 114 in order to form the shutter assembly 110. The method proceeds to step 302, where the base clip 150 gets snap fit to the receptacle cover 4A in order to fixedly couple the base clip 150 to the receptacle cover 4A and thus couple the shutter assembly 110 to the receptacle cover 4A. FIG. 13 is a flow chart for a method 400 that can be employed to assemble the electrical receptacle arrangement 200 that includes the base clip 250, in accordance with an exemplary embodiment of the disclosed concept. At step 401 of the method 400, the shutter 112 and the spring 114 get coupled to the receptacle cover 4B. The method proceeds to step 402, where the base clip 250 gets coupled to the receptacle cover 4B. Step 402 comprises steps 403 and 404. At step 403, the base clip’s lock protrusion 272 gets inserted into the receptacle cover’s lock insertion opening 70. The method proceeds to step 404, where the base clip’s snap fit protrusion 285 gets snap fit into the receptacle cover’s snap fit depression 84.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A base clip for a tamper resistant shutter assembly for an electrical receptacle having a receptacle cover, the base clip comprising:
a main body that is planar in a width dimension and a height dimension, the main body including a hot opening and a neutral opening structured to respectively receive the hot prong and neutral prong of an electrical plug, the hot opening and neutral opening being spaced apart from one another in the width dimension;
a coupling mechanism, the coupling mechanism including:
a coupling base; and
two coupling legs;
a wedge arm, the wedge arm including a wedge arm snap lock protrusion; and
a U-ended arm, the U-ended arm including a U-ended arm snap lock protrusion,
wherein the base clip has a front side and a rear side, the front side being disposed in a frontward direction relative to the rear side and the rear side being disposed in a rearward direction relative to the front side,
wherein the frontward direction and the rearward direction are disposed in a depth dimension,
wherein the depth dimension, width dimension, and height dimension are all orthogonal to each other,
wherein the base clip is structured to be coupled to the receptacle cover with the front side facing the receptacle cover,
wherein the base clip is structured to be coupled to the receptacle cover by aligning the base clip with the receptacle cover and exerting a pushing force in the frontward direction on the receptacle cover, and
wherein the wedge arm and U-ended arm are structured such that, when the pushing force is exerted on the receptacle cover, the wedge arm snap lock protrusion and the U-ended arm snap lock protrusion respectively snap fit into engagement with a first depression and a second depression formed in the receptacle cover, and
wherein the base clip is structured such that the respective engagement between the wedge arm and the U-ended arm with the first depression and the second depression fixedly couples the base clip to the receptacle cover.

2. The base clip of claim 1,
wherein the wedge arm and the U-ended arm are positioned on opposite sides of the main body in the width dimension.

3. The base clip of claim 1,
wherein the base clip is structured to be coupled to a shutter and a spring in order to form the tamper resistant shutter assembly, and
wherein the base clip is structured to be coupled to the shutter and the spring prior to being coupled to the receptacle cover.

4. The base clip of claim 3,
wherein the coupling base extends from the main body in the width dimension such that the coupling base is positioned within the hot opening,
wherein the two coupling legs extend frontward from the coupling base,
wherein the coupling legs are structured to be inserted into a hot opening of the shutter when the base clip is coupled to the shutter, and
wherein the coupling legs are structured to exert a pushing force against the hot opening of the shutter when the base clip is coupled to the shutter.

5. The base clip of claim 4,
wherein the base clip comprises a central axis that is a midline of the main body in the height dimension,
wherein, for each coupling leg, a front end of the coupling leg terminates in a foot that extends away from the central axis, with the foot being the portion of the coupling leg that extends furthest in the height dimension away from the central axis,
wherein each foot comprises a lateral surface that faces away from the central axis,
wherein the coupling legs are structured such that:
in order to couple the base clip to the shutter, a pushing force must be
exerted against the base clip in the frontward direction in order to cause engagement between each foot and a rear side of a corresponding side rail of the shutter,
the engagement between each foot and the rear side of the corresponding side rail causes the coupling legs to first be pushed toward the central axis until each foot has cleared the rear side of the corresponding side rail in the height dimension, and
once the lateral surface of each foot is disposed entirely past a front side of the corresponding side rail in the frontward direction, each of the coupling legs moves away from the central axis and exerts the pushing force against the hot opening of the shutter.

6. The base clip of claim 3,
wherein the wedge arm comprises a spring mount formed on an interior surface that faces the U-ended arm,
wherein the spring mount is structured to mount a first end of the spring when a second end of the spring is mounted to the shutter.

7. A method for assembling a tamper resistant electrical receptacle arrangement, the method comprising:
coupling a base clip to a shutter and a spring to form a shutter assembly; and
snap fitting the base clip to a receptacle cover after formation of the shutter assembly,
wherein snap fitting the base clip to the receptacle cover completes assembly of
the electrical receptacle arrangement ,
wherein the base clip is structured such that snap fitting the base clip to the
receptacle cover fixedly couples the shutter assembly to the receptacle cover.

8. The method of claim 7, wherein the base clip comprises:
a main body that is planar in a width dimension and a height dimension, the main body including a hot opening and a neutral opening structured to respectively receive the hot prong and neutral prong of an electrical plug, the hot opening and neutral opening being spaced apart from one another in the width dimension;
a coupling mechanism, the coupling mechanism including:
a coupling base; and
two coupling legs;
a wedge arm, the wedge arm including a wedge arm snap lock protrusion; and
a U-ended arm, the U-ended arm including a U-ended arm snap lock protrusion,
wherein the base clip has a front side and a rear side, the front side being disposed in a frontward direction relative to the rear side and the rear side being disposed in a rearward direction relative to the front side,
wherein the frontward direction and the rearward direction are disposed in a depth dimension,
wherein the depth dimension, width dimension, and height dimension are all orthogonal to each other,
wherein the base clip is structured to be coupled to the receptacle cover with the front side facing the receptacle cover,
wherein the base clip is structured to be coupled to the receptacle cover by aligning the base clip with the receptacle cover and exerting a pushing force in the frontward direction on the receptacle cover and
wherein the wedge arm and U-ended arm are structured such that, when the pushing force is exerted on the receptacle cover, the wedge arm snap lock protrusion and the U-ended arm snap lock protrusion respectively snap fit into engagement with a first depression and a second depression formed in the receptacle cover, and
wherein the base clip is structured such that the respective engagement between the wedge arm and the U-ended arm with the first depression and the second depression fixedly couples the base clip to the receptacle cover.

9. The method of claim 7,
wherein the wedge arm and the U-ended arm are positioned on opposite sides of the main body in the width dimension.

10. The method of claim 7,
wherein the coupling base extends from the main body in the width dimension such that the coupling base is positioned within the hot opening,
wherein the two coupling legs extend frontward from the coupling base,
wherein the coupling legs are structured to be inserted into a hot opening of the shutter when the base clip is coupled to the shutter, and
wherein the coupling legs are structured to exert a pushing force against the hot opening of the shutter when the base clip is coupled to the shutter.

11. The method of claim 10,
wherein the wedge arm comprises a spring mount formed on an interior surface that faces the U-ended arm,
wherein the spring mount is structured to mount a first end of the spring when a second end of the spring is mounted to the shutter.

12. A base clip for a tamper resistant shutter assembly for an electrical receptacle having a receptacle cover, the base clip comprising:
a main body that is planar is a width dimension and a height dimension, the main body including a hot opening and a neutral opening structured to respectively receive the hot prong and neutral prong of an electrical plug, the hot opening and a neutral opening being spaced apart from one another in the width dimension;
a lock arm, the lock arm including a lock protrusion; and
a snap fit arm, the snap fit arm including a snap fit protrusion,
wherein the lock arm and snap fit arm are disposed on opposite sides of the main body in the width dimension,
wherein the snap fit protrusion is structured to be snap fit into engagement with a snap fit depression of the receptacle cover,
wherein the lock arm and snap fit arm are structured such that, in order to couple the base clip to the receptacle cover, the lock protrusion must be inserted into a lock insertion opening of the receptacle cover prior to the snap fit protrusion being snap fit into engagement with the snap fit depression.

13. The base clip of claim 12,
wherein the base clip is structured to be coupled to the receptacle cover separately from a shutter and a spring of the tamper resistant shutter assembly in order to assemble the tamper resistant shutter assembly.

14. The base clip of claim 12,
wherein the base clip is structured such that a shutter and a spring of the tamper resistant shutter assembly must be coupled to the receptacle cover prior to the base clip being coupled to the receptacle cover in order to assemble the tamper resistant shutter assembly.

15. The base clip of claim 12, further comprising:
a first poka-yoke arm and a second poka-yoke arm,
wherein the first and second poka-yoke arms are formed on a first lateral side of the main body, the first lateral side extending in the width dimension,
wherein the first poka-yoke arm includes a first angled edge,
wherein the second poka-yoke arm includes a second angled edge,
wherein, relative to a plane that lies in the width dimension and the height
dimension, the first lateral side of the main body comprises edges that are either linear solely in the width dimension or linear solely in the height dimension with the exception of the first angled edge and the second angled edge.

16. The base clip of claim 12,
wherein the lock protrusion is structured to be inserted into a lock insertion opening of the receptacle cover,
wherein the lock protrusion comprises a sloped surface structured to engage an overhang formed in the receptacle cover when the lock protrusion is inserted into the lock insertion opening, and
wherein the lock protrusion is structured such that, when the sloped surface is engaged with the overhang, the lock arm remains locked into the receptacle cover when a pulling force is exerted on the base clip solely in a rearward direction that is orthogonal to the width dimension and the height dimension.
